(19) United States
(12) Patent Application Publication
(10) Pub. No.: US 2010/0055280 A1
(43) Pub. Date: Mar. 4, 2010

(54) CONSUMABLE SPICE-CONTAINING FILM AND ALSO PROCESSES FOR PRODUCTION THEREOF

(75) Inventor: Michael Simon, Boppard-Buchholz (DE)

Correspondence Address: D. Peter Hochberg;D. Peter Hochberg Co., L.P.A., 1940 East 6th St.- 6th floor, Cleveland, OH, 44114, US

(73) Assignee: LTS Lohmann Therapie-Systeme AG, Andernach (DE)

(21) Appl. No.: 12/312,313

(22) PCT Filed: Nov. 5, 2007
(86) PCT No.: PCT/EP2007/009564

§ 371 Date: May 5, 2009

(30) Foreign Application Priority Data
Nov. 11, 2006 (DE) 10 2006 053 238.4

(51) Int. Cl. A23L 1/22

(52) U.S. Cl. 426/533; 426/534

(57) ABSTRACT

A consumable spice-containing film for covering or encasing foods. The film comprises a consumable carrier film having a polymer matrix which, as a polymeric base material, contains a polymer which is water-soluble or is soluble in an ethanol-water mixture, or a mixture of at least two such polymers. The carrier film has a smooth bottom side and a top side opposite the bottom side. The top side is provided with a coating of spice particles. The predominant fraction of the spice particles adheres to the surface of the carrier film and penetrates into this only partially, but is not completely enclosed within the carrier film.

### CROSS-REFERENCE TO RELATED APPLICATIONS

This application is a National Stage application of International Application No. PCT/EP2007/009564, filed on Nov. 5, 2007, which claims priority of German application number 10 2006 053 238.4, filed on Nov. 11, 2006, both of which are incorporated herein by reference in their entireties.

### BACKGROUND OF THE INVENTION

1. Field of the Invention

The invention relates to consumable spice-containing films that are suitable for covering or encasing foods for the purpose of seasoning. The invention further relates to processes for producing such films, as well as to the use thereof for seasoning, covering and encasing the most different types of foods.

2. Description of the Prior Art

Edible, spice-containing films—also called spice films—are known per se and are used, for example, for encasing foods such as sausages or ham. The food product which has been treated in this way is seasoned by being in contact with the spice film because the spice compounds or flavours transfer into the food product, bind thereto or diffuse into it. Encasing a food with a spice film may also serve to provide the surface of a food product with a decoration spice. Decoration spices are spices that are used inter alia or above all for their aesthetic effect, for instance coloured spice particles or spice particles having a striking shape, e.g. whole peppercorns.

To produce sausages, cooked ham and meat products, spice casings or spice films that are produced on the basis of non-consumable carrier materials and which after the spice film has been pressed onto the product have to be removed, that is, peeled off. Such spice films are sold by Wiberg GmbH (A-5020 Salzburg) under the name “SUN-SPICE®”. As an additional process step is necessary in order to remove the spice film, the use of such films is disadvantageous. In addition, there is a danger of spice particles becoming detached from the food product or remaining on the spice film when the film is being peeled off. In addition, it can be difficult to find the optimal point in time for detaching the film.

Edible protein films which are suitable for encasing sausages or meat and which are printed with edible colours are also known. Such protein films are available from Naturin GmbH & Co. KG (Weinheim, Germany) under the trade name COFFI®.

Furthermore, edible spice films for encasing foods have been described in WO 95/17100 A1. These are films based on collagen which contain powdered spices as integral ingredient. An advantage of these films is that the powdered spice particles are embedded in the collagen-based matrix layer in a manner such that the predominant part of the overall surface of the spices is located within the collagen layer of the film. As a consequence, the spice particles are for the most part deeply embedded in the collagen matrix or even entirely enclosed by the collagen matrix, thereby preventing large-area interaction of the spice particle surfaces with a food surface covered with such a spice film.

The transfer of spice particles from the spice film into the food product covered therewith, and the diffusion of spice compounds, is thereby impeded. Direct contact between the spice particles, which are enclosed within the collagen matrix, and the respective food surface is largely prevented.

The spice particles described in WO 95/17100 A1 are manufactured by stirring them directly into a collagen suspension, which is then converted into a flat film by extrusion. Alternatively, a collagen suspension is extruded onto a support that has been sprinkled with spice particles. With this method, only insufficient degrees of loading (=percentage of spices relative to the overall mass of the film) can be achieved. In addition, there is a risk that coating with the spices will take place in a non-uniform manner and that there will be gaps or inhomogeneities in the spice layer.

### SUMMARY OF THE PRESENT INVENTION

The object of the present invention was therefore to provide spice-containing films suitable for covering or encasing foods which avoid the above-described disadvantages or at least reduce them, and which, more particularly, enable an even coat of spices with high loading density.

Surprisingly, this object is achieved by means of a consumable, spice-containing film which, according to the present invention, comprises a consumable carrier film having a polymer matrix which, as polymeric base material, contains a polymer which is water-soluble or is soluble in an ethanol-water mixture, or a mixture of at least two such polymers. The carrier film has a smooth bottom side and a top side opposite this which is provided with a coating of spice particles, wherein the predominant fraction of the spice particles adheres to the surface of the carrier film and penetrates into said carrier film only partially, but is not completely enclosed within the carrier film.

Due to the use of a consumable carrier film, the inventive spice-containing films can remain on the food product even after the manufacture of the food product has been completed, and be consumed along with it. This eliminates the necessity of removing the spice film from the food before the latter is taken to the market. As the inventive spice film may remain permanently on the food product treated therewith, only one production step is required to apply the spice film. This constitutes a considerable simplification compared to the spice films and methods known from the prior art.

The top side of the carrier film is provided with a coat of a plurality of spice particles which has a high loading density. Due to the fact that the predominant fraction of the spice particles adheres to the surface of the carrier film and penetrates into the latter only partially, but is not completely enclosed within the carrier film, it is ensured that there is a very efficient direct interaction between the spice coating and a surface of a food product covered therewith. “Predominant fraction” corresponds preferably to at least 55%, more preferably at least 75%, and most preferably at least 90% of the spice particles, with each percentage relating to the overall number of particles in a randomly selected section of the film.

The coating of the carrier film with spice particles is uniform and without gaps, which enables a homogeneous seasoning of a food product covered therewith. In dried condition, that is, in the state following the manufacture and prior to use, the spice particles are firmly anchored in the polymer matrix of the carrier film, and few—or, if at all, negligible—losses due to premature detachment from the carrier film occur. After the spice-loaded carrier film has been brought into contact with the surface of a food, the hydrophile, water-soluble polymers of the polymer matrix act as adhesion-promoting agents between the spice particles and the surface of the respective food or food product (e.g. surface of a piece of meat or a sausage).

The spice-containing films according to the present invention are consumable, that is, they are suitable for human consumption. Polymers as well as auxiliary substances and additives that are suitable for producing consumable products, that is, of food products, are known to those skilled in the art.

The carrier film serves as a structure-imparting element and as a carrier for the spice particles. It comprises a polymer matrix which, as polymeric base material, contains a polymer which is water-soluble or is soluble in an ethanol-water mixture, or a mixture of at least two such polymers. Apart from the afore-mentioned base material, the polymer matrix may contain additives or auxiliary substance in order to modify the chemical and physical properties of the film. For example, the mechanical flexibility of the carrier film (and thereby of the entire spice-containing film) may be increased by adding softeners or/and humectants. Substances suitable for that purpose are known to the person skilled in the art. Substances that are suitable as softeners or humectants are, in particular, glycerine, sorbitol, mannitol, maltitol, propylene glycol, polyethylene glycol, triacetin, citric acid ester, esters of organic polyalcohols, castor oil, acetylated fatty acid glycerides, triethyl citrates, acetyl-tri-n-butyl citrate, acetyl-tri-n-ethyl citrate, dibutyl sebacate, phthalic acid ester, phthalate, dextrose.

The polymer fraction contained in the carrier film preferably amounts to 10 to 90%-wt., more preferably 20 to 70%-wt., with each percentage relative to the carrier film (without the spice portion) in dried condition. The fraction of the optionally present additives and auxiliary substances amounts to 0 to 90%-wt., preferably 5 to 50%-wt.

The carrier film has a smooth bottom side and a top side opposite this which is provided with a coating of spice particles. Consequently, the inventive films are loaded only on one of the two sides thereof with spice particles. The top side provided with the spice particles carries and presents the spice particles at a high density.

According to a preferred embodiment, an inventive spice-containing film has on its top side a rough surface structure that is predominantly or completely determined by the shape of the spice particles that have been applied. Preferably, the surface is covered all over and without any gaps with spice particles.

The smooth structure of the bottom side of the carrier film, which at the same time forms the bottom side of the spice-containing film, is above all determined by the polymer matrix. Preferably the smooth bottom side of the carrier film, which at the same time represents the bottom side of the spice-containing film, forms a continuous, gapless surface. This carrier film may remain, temporarily or permanently, connected with the coating support which during the manufacturing process was used for producing the polymer matrix layer from a liquid coating mass.

The free bottom side (i.e. that side which is not connected with the carrier film) of the coating support is preferably provided with abhesive properties. This can be achieved, in particular, by using a siliconised coating support, for example a release paper that has been siliconised on one side. An advantage of this is that when rolling the dried laminate up and during storage thereof in this rolled-up state, any agglutination and any potential diffusion processes between adjacent layers are prevented since the bottom side, which has been rendered abhesive, (i.e. siliconised) forms the contact side to the spice layer located thereabove.

Suitable as a polymer base material for producing the polymer matrix of the carrier layer are polymers which are water-soluble or soluble in an ethanol-water mixture and which are fit for consumption. Preferably, these are hydrophilic, film-forming polymers. Polymers possessing the aforementioned properties are in principle known to those skilled in the art. The polymer matrix may be produced using only a single polymer species or using a combination of two or more different polymers.

Preferably, the carrier film as a whole is water-soluble, but at least soluble or degradable in the human digestive tract.

The above-mentioned polymers are preferably selected from the group which comprises cellulose derivatives, polyvinyl alcohols, polyacrylates, polyvinyl pyrrolidones, water-soluble polysaccharides and proteins.

According to another preferred embodiment, the polymer matrix of the carrier film consists of a water-soluble polymer base material which is selected from the group which comprises cellulose derivatives, polyvinyl alcohols, polyacrylates, polyacrylic acid, polyvinyl pyrrolidones, polysaccharides, proteins, and combinations of the aforementioned polymers. As required, the polymer matrix may in addition contain auxiliary substances and additives, as described above.

Preferably, cellulose ethers are taken into consideration for use as the cellulose derivatives. More preferably cellulose ethers from the group which comprises hydroxypropylmethyl cellulose, carboxymethyl cellulose, hydroxypropyl cellulose, hydroxymethyl cellulose and methyl cellulose are employed.

The polysaccharides which may be used are, in particular, those of plant or microbial origin. These are preferably selected from the group which comprises pullulan, xanthan, chitosan, alginates, dextrans, pectins and modified starches.

As to the proteins, gelatinizing proteins, especially gelatine and collagens, are preferably taken into consideration.

Polymer matrices based on alginate or hydroxypropylmethyl cellulose having a polymer content of from 20 to 95%-wt., especially 40 to 80%-wt., with each percentage relative to the carrier layer in dried condition, are especially preferred.

The overall layer thickness of the inventive consumable spice-containing films is preferably in the range from 0.2 to 5 mm, preferably in the range from 0.4 to 2 mm. The selection of the layer thickness is dependent on, inter alia, the type and size of the food product to be treated, as well as on the type of the spices applied.

The weight per unit area of the spice-free carrier film is preferably 30 to 200 g/m², more preferably 80 to 150 g/m², in each case relative to the dry weight.

The coating weight of the spices is preferably in the range from 60 to 1500 g/m², particularly in the range from 200 to 700 g/m². The coating weight refers to the amount of spices adhering to the carrier film (in g), relative to one unit area. This shows that with the inventive spice films it is possible to achieve very high degrees of loading and an almost complete saturation of the carrier layer surface with spice particles.

Furthermore, with regard to the loading of the carrier film with spice particles, it is preferred that the mass ratio of spice fraction to carrier film fraction is in the range from 2:1 to 10:1, more preferably in the range from 3:1 to 6:1 (in each case relative to the mass in g). Such a high degree of loading cannot be achieved with conventional methods of production, wherein the spice particles are stirred directly into the polymer mass of the carrier film, because such a high content of spices would strongly increase the viscosity of the polymer mass and because, in addition, the high density of spice particle structures would render it impossible to spread the polymer mass in such a way as to obtain an even and uninterrupted film.

Suitable for use as spice particles are in principle any types of spices or spice formulations that are present in the form of particles or that can be transferred into particle form. Preferably, these spice particles have a particle size in the range from 0.1 to 50 mm, more preferably in the range from 0.5 to 2 mm, with preferably at least 80% of all spice particles falling within the respective size range.

To produce the inventive spice films, for example spices in powder form (particularly with particle sizes in the range from 0.1 to 1 mm), comminuted spice pieces, spice fragments and spice granules (especially in the size range of ≦5 mm), e.g. peppercorns, or even whole, non-comminuted plant parts (preferably in the size range of ≦50 mm), such as, for example, saffron threads or laurel leaves, may be used as spice particles.

Suitable for use as spices that may be contained in the spice particles or of which the spice particles may consist are, generally, plant parts (e.g. leaves, flowers, roots, fruits) or whole plants which because of their natural content of essences and flavour compounds are used as seasoning ingredients or flavour-imparting ingredients in the preparation of all kinds of foods or meals. Suitable spices for use in this regard are, in particular: anise, bear's garlic, basil, berries, savory, chilly, pepper, curry, dill, estragon, eucalyptus, fennel, ginger, sweet calamus, capers, cardamom, chervil, garlic, coriander, caraway, curcuma, lavender, lemongrass, lovage, laurel leaves, mace, marjoram, melissa, horseradish, mint, nutmeg, myrtle, cloves, oregano, paprika, leek, parsley, pepper, mushrooms, pimento, pistachios, rosemary, saffron, sage, chives, black cumin seed, celery leaves, mustard seeds, sesame, star anise, thyme, tomato, truffle, vanilla, juniper berry, woodruff, cinnamon, lemon balm and onion. The above-mentioned spices may be used both singly or in combinations of two or more different spices.

The inventive spice-containing films may contain spice particles that are used mainly for their decorative effect, that is, so-called decoration spices.

Suitable for use as spice particles are, furthermore, spice mixtures, spice formulations, spice preparations, preparations with seasoning formulations, spice flavour formulations (e.g. artificial flavours, such as pizza flavour, cheese flavour or barbecue meat flavour, fruit flavours), spice flavour salts (e.g. garlic salt), meat tenderisers, meat extracts, seasonings and seasoning mixtures, with each of the above-mentioned formulations, preparations, flavour salts and mixtures being present in particulate form, preferably having a particle size in the range of from 0.1 to 50 mm, more preferably in the range of from 0.5 to 2 mm.

According to another embodiment, an inventive consumable, spice-containing film contains spice particles wherein a spice or a spice formulation is present in microencapsulated form. These may, in particular, be spices, spice formulations, essences and flavour compounds, etc., which are initially present in liquid form and are later converted to a particulate form through the microencapsulation.

The invention furthermore encompasses embodiments wherein the spice-containing film contains at least two groups of spice particles that differ in terms of the types of spices contained therein or in terms of their composition. Furthermore, a spice film according to the invention may be produced using spice particles which contain a combination of at least two different spices.

According to another, particularly preferred embodiment of the invention, the consumable spice-containing film contains spice particles that are provided with a coating. This coating may serve various functions, for example as aroma protection or for improving the adherence of the spice particles to the surface of foods. Particularly preferred are adhesive coatings of an adhesive, for example a protein adhesive, that sets with the surfaces of foods (e.g., surfaces of meat or sausages) and ensures strong adhesion of the spice particles to the surface of the food or the surface of the product (so-called “spice adhesives”). Methods of producing such coated spice particles are known to those skilled in the art. Suitable as substances for use in producing the aforementioned coatings, especially adhesive coatings, are, furthermore, flour, starch, maltodextrin, gum arabic, lecithin, alginate, carragheenan, agar agar, pectin, gelatine, casein, sugar alcohols, polyvinyl alcohol, as well as mixtures of two or more of the aforementioned substances, for instance.

The use of spice particles that are provided with an adhesive coat is furthermore advantageous because this also enables an adhesive connection between the spice particles. This may take place already during production, i.e. when the adhesive coat is activated by the moisture contained in the polymer layer, and thereby becomes adhesive. By forming adhesive bonds between neighbouring spice particles, even those spice particles will become fixed in the spice-containing coat which are themselves not anchored in the polymer matrix. Preferably, the adhesive coat is moisture-activatable, which means that spice particles coated therewith can, in dry condition, be sprinkled and are flowable and that the adhesive effect occurs only when the adhesive coat comes into contact with moisture or with an aqueous solution.

The invention furthermore comprises embodiments which provide that on the top side of the carrier film, which side is provided with said spice particles, there are additionally applied one or more formulations selected from the group which comprises spice mixtures, spice formulations, spice preparations, preparations with seasoning formulations, spice flavour formulations, spice flavour salts, meat tenderisers, meat extracts, seasonings and seasoning mixtures. Suitable spice mixtures, spice formulations, etc., are known to those skilled in the art.

Furthermore, the polymer matrix of the carrier film may optionally contain one or more food additives, especially those which are specified in the EU Directives 89/107/EEC, 94/35/EC, 94/36/EC and 95/2/EC. Suitable for use as food additives are, in particular, those selected from the group which comprises antioxidants, emulsifiers, gelling agents, flavour enhancers, flavour compounds, sweeteners, stabilisers, pH regulators, acidifying agents, bulking agents, preservatives, dyes, thickeners, softeners and humectants. Suitable substances which are consumable and which are generally used in food production are known to those skilled in the art. Preferably, auxiliary substances or additives are used which are approved in the EU as food additives and have been assigned an E number. The minimum and maximum amounts in which these substances may be added are known to those skilled in the art; they are derived, for example, from the ADI value (Acceptable Daily Intake) or from the known minimum effective concentrations (e.g. in the case of preservatives).

The inventive consumable, spice-containing films are preferably flexible and may be converted into single sheets or pieces, or into cut shapes, possibly stacked, or into reels. The reels preferably have a width of from 0.2 to 1.5 m, especially from 0.4 to 1 m, and the length of the rolled-up web of film is preferably 2 to 50 m, especially 5 to 25 m.

It is furthermore provided that the spice-containing films may be formed as open cylindrical casings which can be filled with the food product (e.g., sausage or sausage mass) that is to be encased.

To avoid loss of flavour and to avoid other disadvantageous changes of quality, the spice-containing films are preferably protected by a hermetic, that is, aroma-tight and/or water-vapour-tight, package. The present invention furthermore comprises methods of producing consumable, spice-containing films, more particularly films which have the above-described features.

The procedure of manufacturing is generally as follows:

A solution or dispersion is prepared which contains a polymer that is water-soluble or is soluble in an ethanol-water mixture, or a mixture of at least two such polymers;

The liquid (or viscous) polymer mass is spread out on a coating support, whereby a moist polymer matrix layer is obtained. This layer forms the carrier film of the spice-containing film.

The spice particles are applied to the surface of the moist polymer matrix layer, preferably sprinkled thereon. The spice particles penetrate into the polymer matrix only partially and are bound thereto. In this way, a uniform, dense coat of spice particles is formed on the polymer matrix layer.

The polymer matrix layer, which is covered with spice particles, is subsequently solidified, which may be accomplished by withdrawing the solvent, preferably by drying.

To produce the polymer mass and the coat of spice particles, the above-mentioned polymers, spices, spice formulations, spice particles, auxiliary substances and additives, etc., are preferably used.

Before spreading, the viscosity of the polymer mass is set to an appropriate value in a known manner.

The viscosity adjustment is, inter alia, dependent on the respective coating method, the composition of the polymer mass, the desired layer thickness and the coating rate.

In addition to the polymer(s), the polymer mass may possibly contain auxiliary substances and/or additives, such as softeners or humectants. The solids content of the polymer mass intended for coating is preferably in the range of from 5 to 60%-wt., particularly in the range of from 10 to 20%-wt.

The spreading of the polymer mass onto the coating support can be performed using known methods, preferably by roller coating methods. Suitable coating supports are known to those skilled in the art. Generally, these are supports with smooth, inert surfaces, for example paper, plastic films (e.g. polyethylene, polypropylene, PVC), aluminium, steel strips, as well as composite materials (e.g. paper with a polyethylene coating or/and with a siliconisation, or multiple-layer films of, for example, aluminium with a polyethylene coating).

By applying the spice particles to the still moist, that is undried, polymer matrix layer, it is possible to obtain a high degree of spice loading and a very even coating of spice particles. By means of the inventive method it is ensured that the surface of the polymer matrix will be saturated with spice particles. The inventive methods of production enable the processing of spice particles that vary over a wide range as regards their particle size and shape, and they enable anchoring of these particles on a hydrophilic, water-soluble carrier film.

According to a particularly preferred embodiment, spreading of the polymer-containing mass and applying the spice particles takes place in a continuous process, wherein the coating support is continuously conveyed forward together with the polymer matrix layer located thereon, and at the same time the spice particles are scattered in excess, from above, onto the surface of the still moist polymer matrix layer. The coating support—and along with it, the polymer matrix layer located thereon—is subsequently deflected, preferably by means of a deflection roller, whereby the excess spice particles, which are not bound to the polymer matrix layer, are dropped. In this way, a particularly good, complete saturation of the polymer matrix surface with spice particles and a very efficient realisation of the method is achieved.

The excess spice particles, which have been discharged by means of the deflection, can be returned to the process and used again for sprinkling a matrix layer.

Drying the matrix layer loaded with spice particles takes place in a known manner, preferably at elevated temperatures. Preferably, drying is performed at temperatures in a range from 20 to 90° C., more preferably in the range from 40 to 70° C. The residual moisture after drying is preferably in the range from 1 to 10%-wt. The heating or drying devices are generally arranged such that the drying of the polymer matrix layer covered with spice particles starts after the coating support has been deflected, as described above. Alternatively, or in addition thereto, heating or drying devices may be arranged in such a way that the drying begins before the coating support, along with the polymer matrix layer located thereon, reaches the position where it is deflected. Suitable drying methods and drying plants are known to those skilled in the art (e.g. contact drying, ventilation drying, adsorption drying, condensation drying, vacuum drying, hybrid drying).

The inventive consumable, spice-containing films can advantageously, and in a multitude of ways, be used for seasoning foods or for applying decoration spices to foods. Generally, the application takes place in such a manner that the food to be treated is at least temporarily brought into contact with the spice-containing film. After application of the spice-containing film, the film can remain permanently on the food, that is, until the food is consumed; this kind of use is especially preferred. The term “foods” encompasses both untreated foods as well as food products.

The invention further relates to the use of a consumable, spice-containing film of the above-described kind, for covering or encasing foods or food products, especially of solid foods or food products, wherein the film is applied, with one of the two sides thereof (“product contact side”), to a surface of the food to be treated and binds to that surface.

Generally the food treated in this manner is covered or encased by the spice film completely or almost completely. The invention in addition encompasses applications where the food to be treated is covered or encased only partially or is brought into contact with a food, a food product or a meal only for a short period of time or temporarily. The inventive spice-containing films may furthermore be used as a seasoning trimming or ingredient, for example for preserved foods or frozen food products, or as a seasoning cover for barbecue meat, steaks and the like.

The consumable, spice-containing film is preferably applied to the surface of the food or food product by using pressure and/or heat. If the food to be covered has a dry surface, the film's adherence to the surface can be made possible or be improved by moistening the film or the food product.

The spice-containing film may preferably be applied to the food in such a manner that the spice-loaded top-side of the film is brought into contact with the surface of the food. In that case, the top side of the spice film is used as the product contact side. Since the spice particles are present on the inventive films in a large-area spice-particle layer and present a large spice particle surface, a large-area interaction between the spice particles and the surface covered therewith is achieved, and hence optimal adherence. This effect is further increased if the spice particles are, as described above, provided with an adhesive coat which sets on moist surfaces of foods, e.g. meat, and produces a strong adherence of the spice particles on the product surface.

Alternatively, the inventive film may be applied onto a food (or food product) in such a manner that the smooth bottom side of the film, that is, the bottom side of the carrier film, is brought into contact with the surface of the food. This manner of proceeding is advantageous especially where the spice particles are to be visible on the surface of the finished product, for instance in the case of a decoration spice. The hydrophilic water-soluble polymers of the carrier film, after hydration by the moist surface of the food covered with the film, acts as adhesion promoter between the spice particles and the surface of the food product (e.g. the surface of a piece of meat or of a sausage).

The inventive spice-containing films can be used for treating, that is, for seasoning, encasing or covering, the most different kinds of foods and food products, particularly for meat, sausages (e.g. raw sausages, bologna, ham, cooked cured products, cheese, fish, marine animals, bakery products, confectionery, sweets, vegetables, fruit, nuts, deep-frozen foods, ice cream, preserved foods, semi-finished products, snack products and convenience products).

The invention will be explained in the following by reference to the embodiment examples and drawings described hereinbelow. The E numbers (e.g. E 401) indicated refer to the designation system for food additives applicable in the EU countries.

### BRIEF DESCRIPTION OF THE DRAWINGS

FIG. 1 is a cross-section sectional perspective view of the film according to the present invention.

FIG. 2A and FIG. 2B are perspective representations of two alternative methods of utilising the film according to the present invention.

FIG. 3 is a perspective view of a sausage product encased with a film according to the present invention.

### DETAILED DESCRIPTION OF THE PRESENT INVENTION

### Example 1

### Production of a Consumable Curry Spice Film for Encasing Foods

Step 1: A viscous solution in water, with a solids content of approximately 18.0%-wt., is prepared which consists of 10.6%-wt. sodium alginate (E 401), 7.2%-wt. glycerine (E 422), 0.18%-wt. curcumin (E 100) and 0.036%-wt. potassium sorbate (E 202).

Step 2: This viscous mass is spread, by a roller coating method, on the non-siliconised side of a POLYSLIK® 11/18 coating paper (as coating support; supplier: Loparex), corresponding to a matrix dry weight of approximately 110 g/m².

Step 3: A curry powder that has been covered with a spice adhesive is sprinkled onto the still moist spread, over the entire surface of said spread and in an excessive amount. Curry powder mainly consists of the ground rhizome of turmeric (Curcuma). More than 90% of the particles of the curry spice used is within a size range of ≦800 μm, and approximately 65% of the particles falls within a size range of ≧560 μm. Excess, i.e. unbound, spice particles are discarded by diverting the coating support (POLYSLIK® paper).

Step 4: The spread scattered with spice is then dried at 60° C. After that, the total weight is approximately 480 g/m², which corresponds to a load of curry of approximately 370 g/m² on the matrix top side. The approximately 1200-μm-thick spice film may then be wound on reels. Due to the siliconised side of the coating support, any sticking together of the plies of the spice film reel lying on top of one another is prevented.

The film is suitable for application on the surface of cooked cured products, for example. The spice-containing coarse topside of the film is characterised by a full-area loading with curry spice particles and can be used as the product contact side. The adhesive coating on the spice particles can set, directly and over the entire surface area, with the meat surface.

### Example 2

### Production of a Consumable Peppercorn Film for Covering Foods

Step 1: A viscous solution in water, with a solids content of approximately 15.0%-wt., is prepared which consists of 13.5%-wt. hydroxy propyl methyl cellulose 50 cps, Type 2910 (E 464), 1.5%-wt. glycerine (E 422) and 0.03%-wt. potassium sorbate (E 202).

Step 2: This viscous mass is spread out, using a roller coating method, onto the non-siliconised side of a POLYSLIK®11/18 coating paper, corresponding to a matrix dry weight of approximately 120 g/m².

Step 3: A spice consisting of fragments of black pepper corns (Piper nigrum) is sprinkled onto the still moist spread, over the entire surface thereof and in an excessive amount.

More than 85% of the particles of the peppercorns used are within the size region ≦800 μm, and approximately 65% of the particles are within a size range of ≧560 μm. Excess, that is, non-bound pepper particles are dropped by deflecting the coating support. Step 4: The spread, which has been scattered with the spice, is then dried at 60° C. After that, the total weight is approximately 520 g/m², which corresponds to a load of pepper of approximately 400 g/m² on the matrix top side. The approximately 1100-μm-thick spice film can subsequently be rolled up on reels. The film is suitable for application to the surface of, for example, cooked cured products. The bottom side, that is, the polymer matrix side, is characterised by a smooth surface, and in the instant example it is used as the product contact side. The bottom side of the pepper film is pressed onto the surface of the meat by application of pressure and elevated temperatures. After cooling, the polymer matrix remains as a thin layer on the surface of the meat and, serving as an adhesive layer/adhesion promoter, binds the peppercorn fragments to the surface.

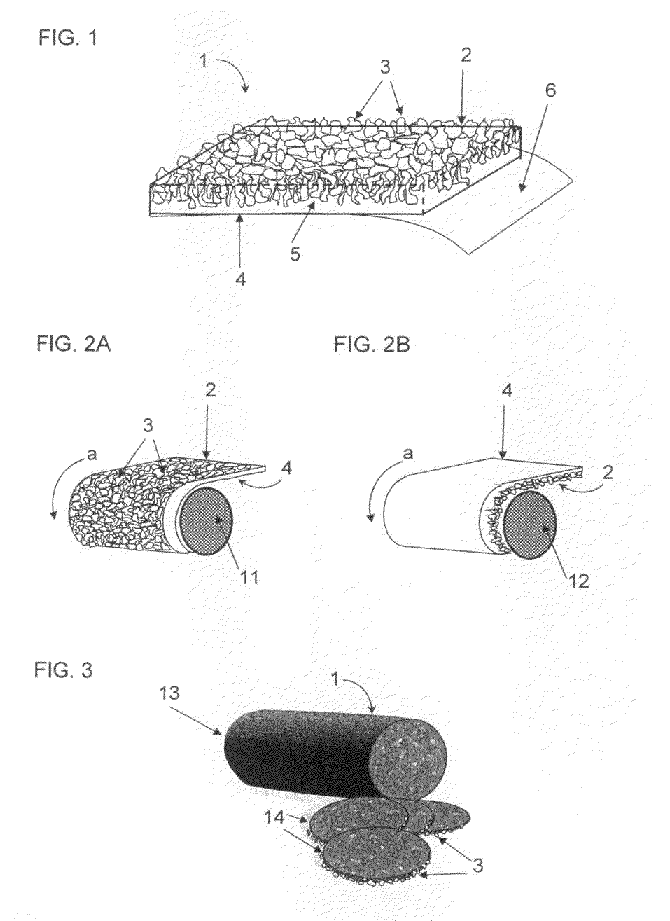

FIG. 1 shows an embodiment of an inventive, consumable, spice-containing film (1), in perspective representation and in sectional representation. The spice film (1) has a rough top side (2), which is characterised by an all-over, dense loading with a plurality of spice particles (3). The spice particles (3) adhere to the carrier film (5), which is formed from a polymer matrix, and penetrate, partially, into that polymer matrix, but they are not completely enclosed within said matrix. The greater number of the spice particles is anchored on the surface of the carrier film, and the neighbouring spice particles are in close contact with one another and overlap each other in part. The carrier film (5) has a smooth bottom side (4). In the present example, this bottom side is provided with a coating carrier (6), also referred to as a coating support. This coating carrier is used during the production process for spreading the viscous polymer mass thereon, as described above. The coating carrier (6), for example a paper that has been coated with polyethylene on both sides and has been siliconised on one side, can be peeled off the bottom side of the spice film after the spice-covered polymer matrix layer has dried or, alternatively, shortly prior to use of the spice film (for covering or encasing a food product).

A spice film having the schematic configuration shown in FIG. 1 can be obtained, for example, by means of the methods as described in the above-described Examples 1 and 2.

FIG. 2A and FIG. 2B show—in perspective representation—two alternative, preferred methods of utilising the inventive spice film, for example a film as shown schematically in FIG. 1 or as described in the embodiment examples.

According to FIG. 2A a food product (11), e.g. a sausage, is covered with the inventive spice film (1) in such a manner that the smooth bottom side (4) of the polymer layer (carrier film) comes into contact with the surface of the food. The process of encasing is indicated by the arrow (a). In the present case, the bottom side (4) of the polymer layer, which at the same time represents the bottom side of the spice film, forms the product contact side. The polymer layer, especially the hydrophilic, water-soluble polymers contained therein, serve as adhesion promoters between the spice particles (3) and the surface of the foods.

In the method shown in FIG. 2B of using an inventive spice film (1), the rough top side (2) of the spice film, which side has been loaded with spice particles, is used as the product contact side, which comes into contact with the top side of the food (12) (e.g. a sausage) and which envelops the food. In the present case, the smooth bottom side (4) of the spice film forms the outer surface of the encased food product. This method of use is particularly advantageous if the spice particles applied to the spice film are provided with an adhesive coat (“spice adhesive”), as described further above. This promotes a direct adherence of the coated spice particles over the entire surface of the encased food product.

FIG. 3 shows a sausage product (13) encased with an inventive spice film (1). Such a sausage product can be obtained, for example, in accordance with the method described in FIG. 2A. The spice particles (3) applied with the spice film to the surface of the sausage (e.g. peppercorns, as described in Example 2) adhere firmly and are even still present at the outer edges of the cut-off sausage slices (14).

The present invention is suitable for use in numerous and advantageous ways for seasoning, encasing and decorating food products, and enables a more efficient and more cost-effective production of food products.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, combinations, modifications, and variations that fall within the spirit and scope of the appended claims.

I claim:

1. Consumable spice-containing film for covering or encasing foods, said film comprising
a consumable carrier film having a polymer matrix comprising a polymer as a polymeric base material, the polymer being water-soluble is soluble in an ethanol-water mixture, or a mixture of at least two such polymers; and wherein
the carrier film comprises a smooth bottom side and a top side opposite said bottom side, wherein a coating of spice particles is provided with said top side, and wherein the predominant fraction of the spice particles adheres to the surface of the carrier film and partially penetrates into said carrier film and is not completely enclosed within the carrier film.

2. The consumable spice-containing film according to claim 1, further comprising a rough surface structure on said top side, the rough surface structure being predominantly or completely determined by the shape of the spice particles applied to the film, and wherein the smooth structure of the bottom side of the carrier film simultaneously forms the bottom side of the spice-containing film, and is predominantly determined by the polymer matrix.

3. The consumable spice-containing film according to claim 1, wherein said bottom side, which is opposite the top side provided with the spice particles, comprises a smooth and closed structure.

4. The consumable spice-containing film according to claim, wherein the polymer(s) are selected from the group consisting of cellulose derivatives, polyvinyl alcohols, polyacrylates, polyacrylic acid, polyvinyl pyrrolidones, water-soluble polysaccharides and proteins.

5. The consumable spice-containing film according to claim 1, wherein the polymer matrix comprises a polymer base material selected from the group consisting of cellulose derivatives, polyvinyl alcohols, polyacrylates, polyvinyl pyrrolidones, polysaccharides, proteins, and combinations of the aforementioned polymers.

6. The consumable spice-containing film according to claim 5, wherein said cellulose derivatives are cellulose ethers.

7. The consumable spice-containing film according to claim 5, wherein said polysaccharides are of vegetable or microbial origin and are selected from the group consisting of pullulan, xanthan, chitosan, alginates, dextrans, pectins and modified starches.

8. The consumable spice-containing film according to claim 5, wherein said proteins are gelatinizing proteins.

9. The consumable spice-containing film according to claim 1, wherein said film comprises an overall layer thickness of 0.2 to 5 mm.

10. The consumable spice-containing film according to claim 1, wherein the dry weight per unit area of the spice-free carrier film is 30 to 200 g/m².

11. The consumable spice-containing film according to claim 1, wherein the mass ratio of spice particles to carrier film is in the range of from 2:1 to 10:1.

12. The consumable spice-containing film according to claim 1, wherein the coating weight of the spices is 60 to 1500 g/m².

13. The consumable spice-containing film according to claim 1, wherein said spice particles have a particle size in the range of from 0.1 to 50 mm.

14. The consumable spice-containing film according to claim 1, further comprising spice particles which, as a spice or spices, contain herbs or plant parts or comprise herbs or plant parts the spice particles being at least one selected from the group consisting of anise, bear's garlic, basil, berries, savory, chilly, pepper, curry, dill, estragon, eucalyptus, fennel, ginger, sweet calamus, capers, cardamom, chervil, garlic, coriander, caraway, curcuma, lavender, lemongrass, lovage, laurel leaves, mace, marjoram, melissa, horseradish, mint, nutmeg, myrtle, cloves, oregano, paprika, leek, parsley, pepper, mushrooms, pimento, pistachios, rosemary, saffron, sage, chives, black cumin seed, celery leaves, mustard seeds, sesame, star anise, thyme, tomato, truffle, vanilla, juniper berry, woodruff, cinnamon, lemon balm and onion.

15. The consumable spice-containing film according to claim 14, further comprising at least one formulation applied on the top side of the carrier film, said at least one formulation being provided with said spice particles, said at least one formulation being selected from the group consisting of spice mixtures, spice formulations, spice preparations, preparations containing seasoning formulations, spice flavour formulations, spice flavour salts, meat tenderisers, meat extracts, seasonings and seasoning mixtures.

16. The consumable spice-containing film according to claim 1, wherein said film comprises at least two groups of spice particles which differ in terms of the kind of spices contained in said groups of spice particles or in terms of the composition of the groups of spice particles.

17. The consumable spice-containing film according to claim 1, wherein said film comprises spice particles comprising a combination of at least two different spices.

18. The consumable spice-containing film according to claim 1, wherein said film comprises spice particles having a coat.

19. The consumable spice-containing film according to claim 1, wherein said film comprises spice particles wherein a spice or a spice formulation is present in a microencapsulated form.

20. The consumable spice-containing film according to claim 1, wherein said the polymer matrix of the carrier film contains at least one substance selected from the group consisting of antioxidants, emulsifiers, gelling agents, flavour enhancers, flavouring substances, sweeteners, stabilisers, pH regulators, acidifiers, bulking agents, preservatives, dyes, thickeners, softeners and humectants.

21. The consumable spice-containing film according to claim 1, wherein said film is present in a configuration selected from the group consisting of a cut shape, a reel and a cylindrical casing.

22. A process for producing a consumable spice-containing film comprising the steps of:
preparing a solution or dispersion containing a polymer which is water-soluble or is soluble in an ethanol-water mixture, or a mixture of at least two such polymers to form a liquid polymer mass;
spreading the liquid polymer mass on a coating support to obtain a moist polymer matrix layer having a surface;
applying spice particles to the surface of the moist polymer matrix layer; and
withdrawing the solvent to solidify the polymer matrix layer, which is covered with spice particles.

23. The process according to claim 22, further comprising the step of adding at least one additive during the preparation of the solution or dispersion, said at least one additive being selected from the group consisting of antioxidants, emulsifiers, gelling agents, flavour enhancers, flavouring substances, sweeteners, stabilisers, pH regulators, acidifiers, bulking agents, preservatives, dyes, thickeners, softeners and humectants.

24. The process according to claim 22, wherein the steps of spreading the polymer mass and applying the spice particles takes place in a continuous process, wherein the coating support is conveyed forward along with the polymer matrix layer located thereon and, simultaneously, the spice particles are scattered, in an excessive amount, onto the surface of the still moist polymer matrix layer, and further comprising the step of deflecting the coating support to drop the excess spice particles which are not bound to the polymer matrix layer.

25. Use of a consumable spice-containing film for seasoning foods or for applying decoration spices onto foods, said film comprising a consumable carrier film having a polymer matrix comprising a polymer as a polymeric base material, the polymer being water-soluble or is soluble in an ethanol-water mixture, or a mixture of at least two such polymers; and wherein
the carrier film comprises a smooth bottom side and a top side opposite said bottom side, wherein a coating of spice particles is provided with said top side, and wherein the predominant fraction of the spice particles adheres to the surface of the carrier film and partially penetrates into said carrier film and is not completely enclosed within the carrier film, comprising the step of bringing the food to be treated, at least temporarily, into contact with the spice-containing film.

26. Use of a consumable spice-containing film for covering or encasing foods, said film comprising a consumable carrier film having a polymer matrix comprising a polymer as a polymeric base material, the polymer being water-soluble or is soluble in an ethanol-water mixture, or a mixture of at least two such polymers; and wherein the carrier film comprises a smooth bottom side and a top side opposite said bottom side, wherein a coating of spice particles is provided with said top side, and wherein the predominant fraction of the spice particles adheres to the surface of the carrier film and partially penetrates into said carrier film and is not completely enclosed within the carrier film, comprising the step of applying said film to a surface of the food to be treated and binding to that surface.

27. Use according to claim 25, wherein the consumable spice-containing film is applied to the surface of the food using pressure and/or heat.

28. Use according to claim 27, wherein the film is applied to the food in a manner such that the spice-loaded top side of the film is brought into contact with the surface of the food.

29. Use according to claim 27, wherein the film is applied to the food in a manner such that the smooth bottom side of the film is brought into contact with the surface of the food.

30. Use according to claim 25, wherein the food is selected from the group consisting of meat, sausages, ham, cooked cured products, cheese, fish, marine animals, bakery products, confectionery products, sweets, vegetables, fruits, nuts, frozen foods, ice cream, preserved foods, semi-finished products, snack products and convenience products.

31. The consumable spice-containing film according to claim 6, wherein said cellulose ethers are selected from the group consisting of hydroxypropylmethyl cellulose, carboxymethyl cellulose, hydroxypropyl cellulose, hydroxymethyl cellulose and methyl cellulose.

32. The consumable spice-containing film according to claim 8, wherein said gelatinizing proteins are selected from the group consisting of gelatine and collagens.

33. The consumable spice-containing film according to claim 9, wherein said film comprises an overall layer thickness of 0.4 to 2 mm.

34. The consumable spice-containing film according to claim 10, wherein the dry weight per unit area of the spice-free carrier film is 80 to 150 g/m².

35. The consumable spice-containing film according to claim 11, wherein the mass ratio of spice particles to carrier film is in the range of 3:1 to 6:1.

36. The consumable spice-containing film according to claim 12, wherein the coating weight of the spices is 200 to 700 g/m².

37. The consumable spice-containing film according to claim 13, wherein said spice particles have a particle size in the range of from 0.5 to 2 mm.

38. The consumable spice-containing film according to claim 18, wherein said film comprises spice particles having an adhesive coat.

39. The process according to claim 22, wherein said step of withdrawing the solvent to solidify the polymer matrix layer comprises drying.

40. The process according to claim 24, wherein the step of deflecting the coating support comprises deflecting the coating support via a deflection roll.

41. Use according to claim 26, wherein the consumable spice-containing film is applied to the surface of the food using pressure and/or heat.

42. Use according to claim 26, wherein the film is applied to the food in a manner such that the spice-loaded top side of the film is brought into contact with the surface of the food.

43. Use according to claim 26, wherein that the film is applied to the food in a manner such that the smooth bottom side of the film is brought into contact with the surface of the food.

44. Use according to claim 26, wherein the food is selected from the group consisting of meat, sausages, ham, cooked cured products, cheese, fish, marine animals, bakery products, confectionery products, sweets, vegetables, fruits, nuts, frozen foods, ice cream, preserved foods, semi-finished products, snack products and convenience products.
